(19) United States
(12) Patent Application Publication
(10) Pub. No.: US 2007/0152113 A1
(43) Pub. Date: Jul. 5, 2007

(54) Compressed workspace notebook computer

(76) Inventors: James M. Okuley, Portland, OR (US); Truong V. Phan, Hillsboro, OR (US); Ron D. Egger, Banks, OR (US); Kelan C. Silvester, Portland, OR (US); Johann Weber, Kirchheim (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/323,109

(22) Filed: Dec. 30, 2005

(51) Int. Cl. A47F 5/12; F16B 21/09

(52) U.S. Cl. 248/133; 403/315; 16/342

(57) ABSTRACT

A computer system is disclosed herein. The computer system includes a base, a plurality of keys supported by the base, at least one arm having first and second ends, the first end being pivotally secured to the base, and a screen secured to the second end of the arm. In one embodiment, the arm is extensible. In one embodiment, the screen is pivotal relative to the arm. In one embodiment, the arm is extensible and the screen is pivotal relative to the arm.

### FIELD

Embodiments of the invention generally relate to the field of computer systems and, in particular, to a computer system having an extensible arm.

### BACKGROUND

Laptop computers, also referred to as notebook personal computers (PCs), are typically lightweight, portable computer systems. These laptop computers have a screen and a base coupled to one another by two clamshell-type hinges. In these laptop computers, the screen can only be adjusted by opening and closing the screen using the clamshell-type hinges. Thus, the range of motion is limited to a simple, partial rotation about the clamshell-type hinges.

A laptop computer is advantageous because it can be easily transported and used by a user in different environments including, for example, on an airplane, in a library, at a coffee shop, etc. However, on airlines, if the passenger sitting in front of the user reclines their seat back, the user must adjust their screen by partially closing the screen. Often, the user's view of the screen may be so limited that they may have to stop using their computer while the passenger's seat is reclined.

There are some laptop computers that can be transformed into a tablet for airline use. However, these laptop computers do not allow the user to continue to use the keyboard.

The traditional laptop computers are also not ergonomic for most users. For example, if the keyboard is positioned at the correct position ergonomically, the screen is often too low; but, if the screen is positioned correctly, the keyboard is typically too high.

### BRIEF DESCRIPTION OF THE DRAWINGS

Embodiments of the invention are described by way of example with reference to the accompanying drawings, wherein:

FIG. 1 is a rear perspective view of a computer system having an extensible arm in accordance with one embodiment of the invention;

FIG. 2 is a front perspective view of a computer system having an extensible arm in accordance with one embodiment of the invention;

FIG. 3 is a top view of a computer system having an extensible arm shown in a closed position in accordance with one embodiment of the invention;

FIG. 4 is a front view of a computer system having an extensible arm shown in an open position in accordance with one embodiment of the invention;

FIG. 5 is a front perspective view of a computer system having an extensible arm shown in a height-adjusted position in accordance with one embodiment of the invention;

FIG. 6 is a front perspective view of a computer system having an extensible arm shown in a height-adjusted position with a pivoted screen in accordance with one embodiment of the invention;

FIG. 6A is a side view of the computer system shown in FIG. 6 in accordance with one embodiment of the invention;

FIG. 7 is a front perspective view of a computer system having an extensible arm shown in a presentation position in accordance with one embodiment of the invention;

FIG. 8 is a side view of a computer system having an extensible arm showing a locking mechanism in accordance with one embodiment of the invention;

FIG. 9 is a rear, partial cross-sectional view of a computer system having an extensible arm showing electrical connections in the arm in accordance with one embodiment of the invention;

FIG. 10 is a side view of a computer system having an arm and a ball joint in accordance with one embodiment of the invention;

FIG. 11 is a rear perspective view of a computer system having a ball joint and a sliding mechanism in accordance with one embodiment of the invention;

FIGS. 12A-D are side views of a computer system having a ball joint and a sliding mechanism showing a plurality of positions for the computer system in accordance with one embodiment of the invention;

FIG. 13 is a rear perspective view of a computer system having a ball joint in accordance with one embodiment of the invention;

FIG. 14 is a front view of a computer system having a height adjustable and swivelable screen in accordance with one embodiment of the invention;

FIG. 15 is a front perspective view of a computer system having first and second arms on opposing sides of the computer system in accordance with one embodiment of the invention;

FIG. 16 is a front perspective view of a computer system having an arm on one side of the computer system in accordance with one embodiment of the invention;

FIG. 17 is a schematic side view of a computer system in any of the above computer systems in use on a plane in accordance with one embodiment of the invention; and

FIG. 18 is block diagram of a computer system in accordance with one embodiment of the invention.

### DETAILED DESCRIPTION

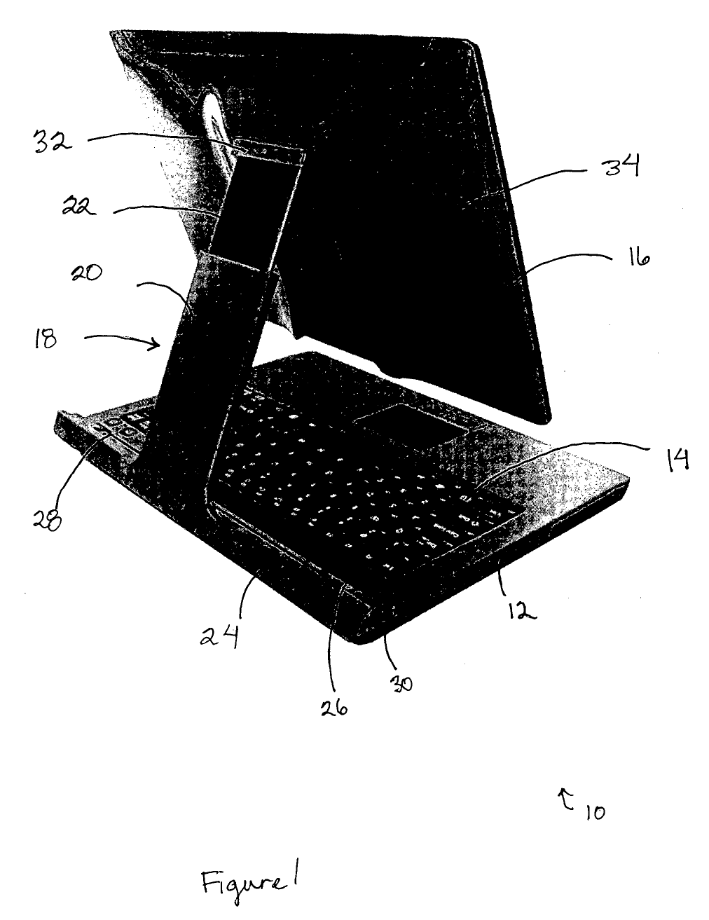

FIG. 1 of the accompanying drawings illustrates a computer system 10. In one embodiment, the computer system 10 includes a base 12, a plurality of keys 14, a screen 16, and an extensible arm 18. The arm 18 may include first, second and third parts 20, 22 and 24, respectively. The third part 24 may include first and second hinges 26 and 28, respectively. The base 12 may include a flange 30. The second part 22 of the arm 18 may include a connection 32.

In one embodiment, the base 12 supports the plurality of keys 14. The plurality of keys together form a keyboard, which may be similar to conventional computer systems. The base 12 may include other user input mechanisms, such as a touch or track pad. The base 12 may include a central processing unity (CPU), memory, storage devices, bus, electronic components, circuit boards and the like. The base 12 may also include connections to external devices such as, for example, a mouse, external memory devices, and other external input/output (I/O) devices. The base 12 may also include wireless connections.

In one embodiment, the base 12 and the screen 16 are electrically connected with one another. The screen 16 may be optically or wirelessly connected to the base 12. The screen 16 may be any device used for displaying information. The screen 16 may be an LCD device. The screen 16 may also include a processor, electronic components, circuit boards and the like. The screen 16 may be powered by a battery.

In one embodiment, the first part 20 of the arm 18 is joined with the third part 24 to form a “T”-shaped arm 18. The third part 24 may be an elongate partial cylinder, which is shown extending the length of the base 12. In one embodiment, the first part 20 extends vertically away from the third part, and typically has a generally rectangular outer shape. In one embodiment, the first part 20 has an opening corresponding to the outer shape of the second part 22. The first part 20 may slideably receive the second part 22 in the opening. In some embodiments, the arm 18 is, therefore, telescoping (i.e., the second part 22 telescopes with respect to the first part 20).

The third part 24 is shown extending from one end of the base 12 to the other end of the base 12; however, it is envisioned that the third part 24 need not extend all the way to either end of the device. It is also envisioned that the first part 20 of the arm 18 may instead be pivotally connected to the base 12 (i.e., the third part 24 is not required and the arm 18 is not necessarily “T”-shaped).

The second part 22 may include a track or other guide to direct the range of motion of the first part 20. Alternatively, the first part 20 may include the track or guide. The track or guide may also include a locking mechanism to secure the screen at a particular height, as will be described hereinafter. Friction may be used to hold the second part 22 at a particular position relative to the first part 20. In one embodiment, the track or guide may include a series of grooves or notches to hold the position of the second part 22.

The third part 24 may be pivotally secured to the base 12. The third part 24 is shown pivotally secured to the base 12 via hinges 26 and 28. Hinges 26 and 28 may be integral with or connected to the third part 24. The hinges 26 and 28 may be secured to the flange 30 of the base 12. The hinges 26 and 28 may be the same or similar to the clamshell-type hinges used with conventional laptop computers.

In one embodiment, the second part 22 of the arm 18 is connectable with the screen 16 via the connection 32. Any connection can be used to connect the arm 18 to the screen 16 that allows the screen 16 to be pivotal relative to the arm 18. It is also envisioned that a computer system that does not have a pivotal connection between the arm 18 and the screen 16, such that the screen 16 is merely height adjustable, may be used.

The flange 30 is typically integral with the base 12 and is located where the arm 18 is connectable with the base 12. The flange 30 is shown having a round shape. The third part 24 may be at least partially positioned over the flange 30. In one embodiment, the third part 24 corresponds to the shape of the flange 30, such that the third part 24 can rotate relative to the flange 30.

The screen 16 may include a recess 34. The recess 34 may be dimensioned to receive the arm 18. The recess 18 may include a locking mechanism to hold the arm 18 within the recess 34 unless force is applied by the user to separate the arm from the recess 34. The recess 34 is optional: instead of the arm resting in the recess 34, the arm 18 can be external to the screen 16.

Although the arm 18 has been described as having a first part 20 and a second slideable part 22, any arrangement can be used with the computer system 10 that allows the height of the screen to be adjusted or that allows the arm to be extensible. For example, in one embodiment, the arm 18 may be a bellows-type device. The arm 18 may also be telescoping with multiple sections articulated to extend out and retract in.

The base 12 and/or the screen 16 may be removably connected to the arm 18. The hinges 26 and 28 may be horizontally adjustable. Connection 32 may allow the screen 16 to pivot so that the screen 16 is facing in the opposite direction (i.e., the screen 16 is flipped). In an embodiment where the screen 16 can be flipped, the screen 16 may include a sensor so that the image displayed on the screen 16 appears correctly when the screen 16 has been flipped. The hinges 26 and 28 may include a sliding mechanism, such that the height of the screen 16 can be adjusted via hinges 26 and 28 (i.e., arm 18 is incorporated into the hinges 26 and 28).

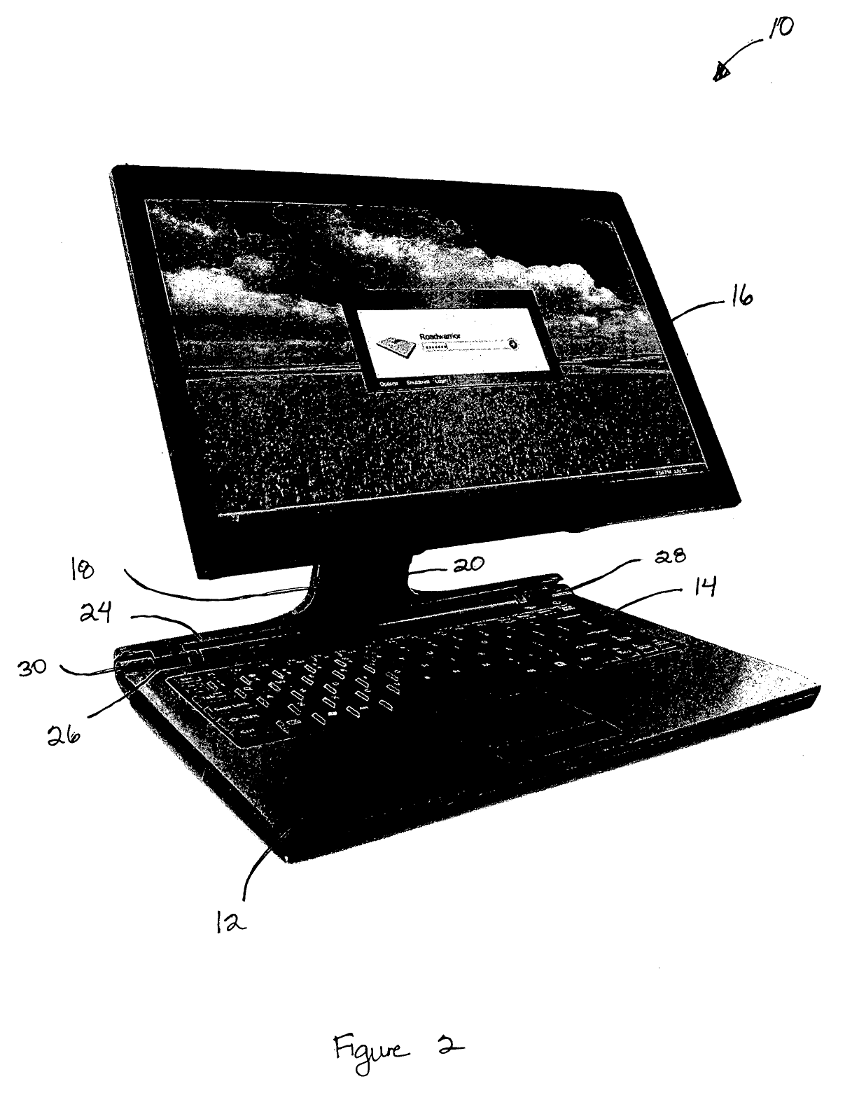

FIG. 2 shows a front view of the computer system 10 shown in FIG. 1. The computer system 10 is shown in an open position, in which the height of the screen 16 with respect to the base 12 has been adjusted. The angle of the screen 16 has also been adjusted, such that the screen 16 is tilted away from the arm 18.

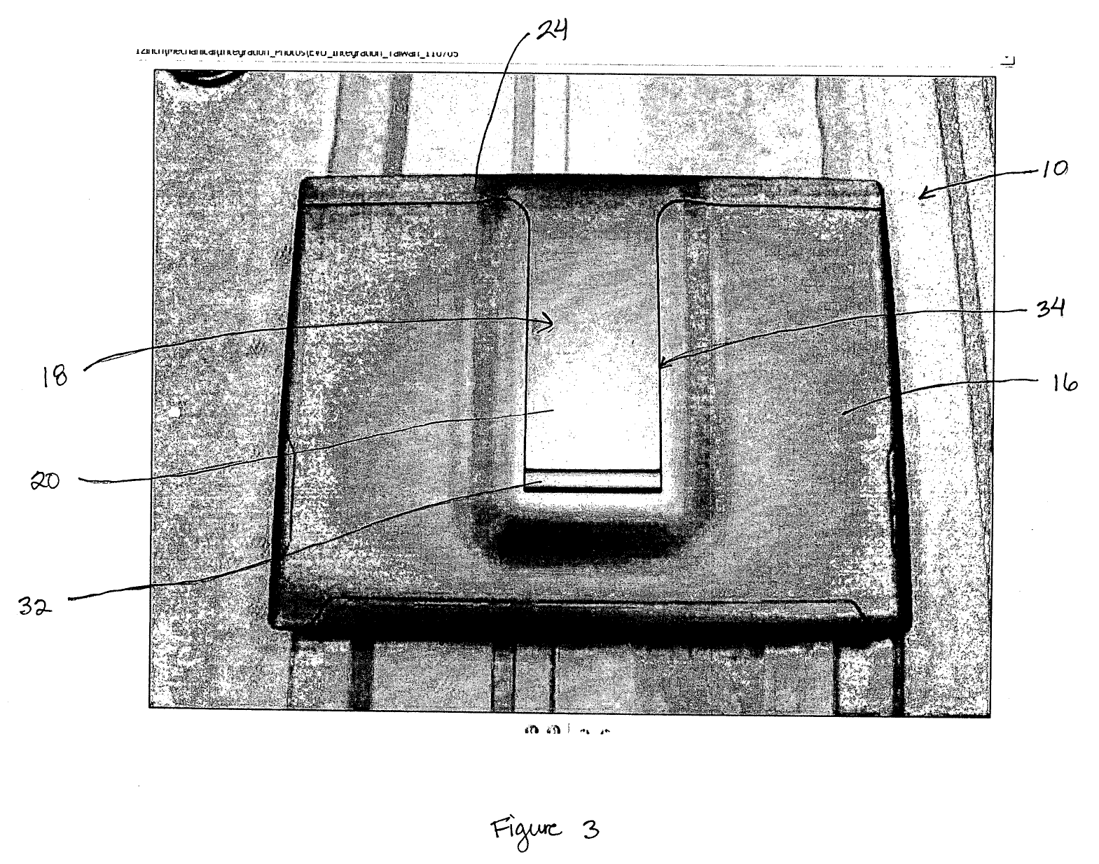

FIG. 3 shows the computer system 10 of FIG. 1 in a closed position. The closed position of the computer system 10 may be similar to a closed position for conventional notebook-style computer systems. As described above, conventional note-book style computer systems typically use clamshell-type hinges, and movement of the screen is a partial rotation about the clamshell-type hinge.

In some embodiments, the screen 16 covers the base 12 (not shown). In some embodiments, the third part 24 covers the flange 30 (not shown). The arm 18 is shown within the recess 34 of the screen 16. In one embodiment, the second part 22 of the arm 18 is entirely within the opening in the first part 20.

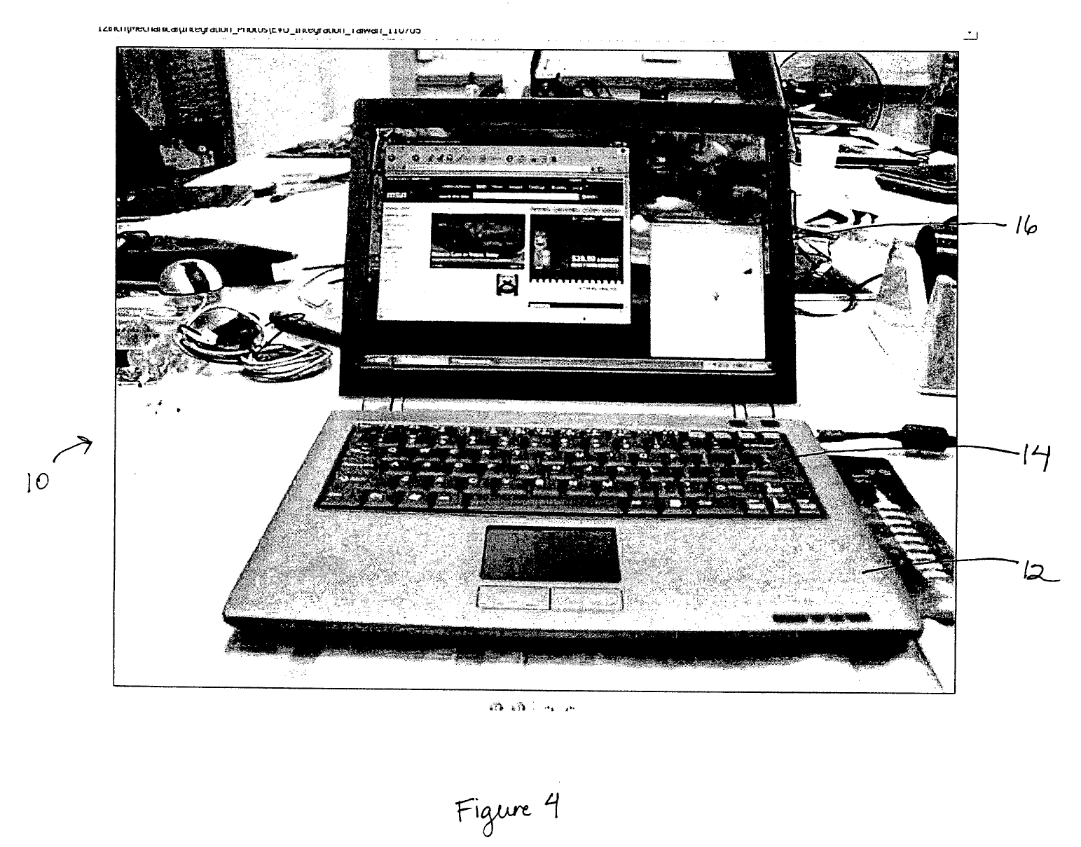

FIG. 4 shows the computer system 10 of FIG. 1 in a first open position. The first open position of the computer system 10 may be similar to the open position for conventional notebook-style computer systems. In one embodiment, the angle of the screen 16 relative to the base 12 is adjustable by the user and may be any angle allowed by the hinges 26 and 28.

The height of the screen 16 relative to the base 12, and the angle of the screen 16 relative to the arm 18 have not been adjusted. The screen 16 may arrive at the illustrated position in a manner similar to conventional notebook-style computer systems. The screen 16 is pivoted relative to the base 12 when the user applies a force to the screen 16 to rotate it. The third part 24 of the arm 18 at least partially rotates about the flange 30 via hinges 26 and 28, when the user lifts and rotates the screen 16.

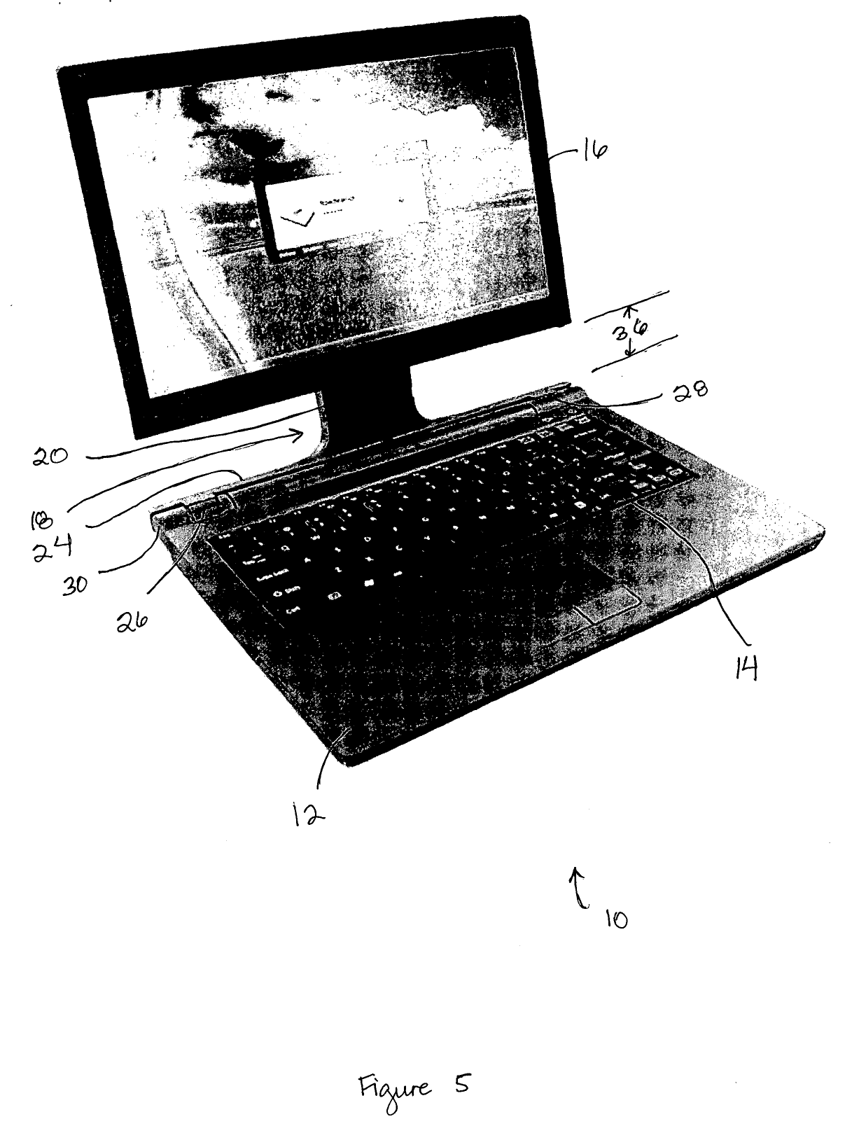

FIG. 5 shows the computer system 10 of FIG. 1 in a height-adjusted open position. In the illustrated embodiment, the arm 18 has been extended, such that a distance 36 separates the screen 16 and the base 12.

In some embodiments, the height of the screen 16, represented by the distance 36, is adjustable. The height adjustment may be flexible, so any user can position the screen 16 at any height, depending on the particular circumstances of the user. The distance 36, in some embodiments, is sufficient that a user's hands can fit between the bottom edge of the screen 16 and the top surface of the base 12, so the user can still access the keys 14.

In one embodiment, the height of the screen 16 is adjusted by sliding the second part 22 of the arm 18 relative to the first part 20. The user may have to apply a force to the screen 16 to cause the second part 22 to move relative to the first part 20. The arm 18 may remain within the recess 34 if only the height of the screen 16 is being adjusted. Thus, the height of the screen 16 can be adjusted independent of adjusting the angle of the screen 16 relative to the base 12.

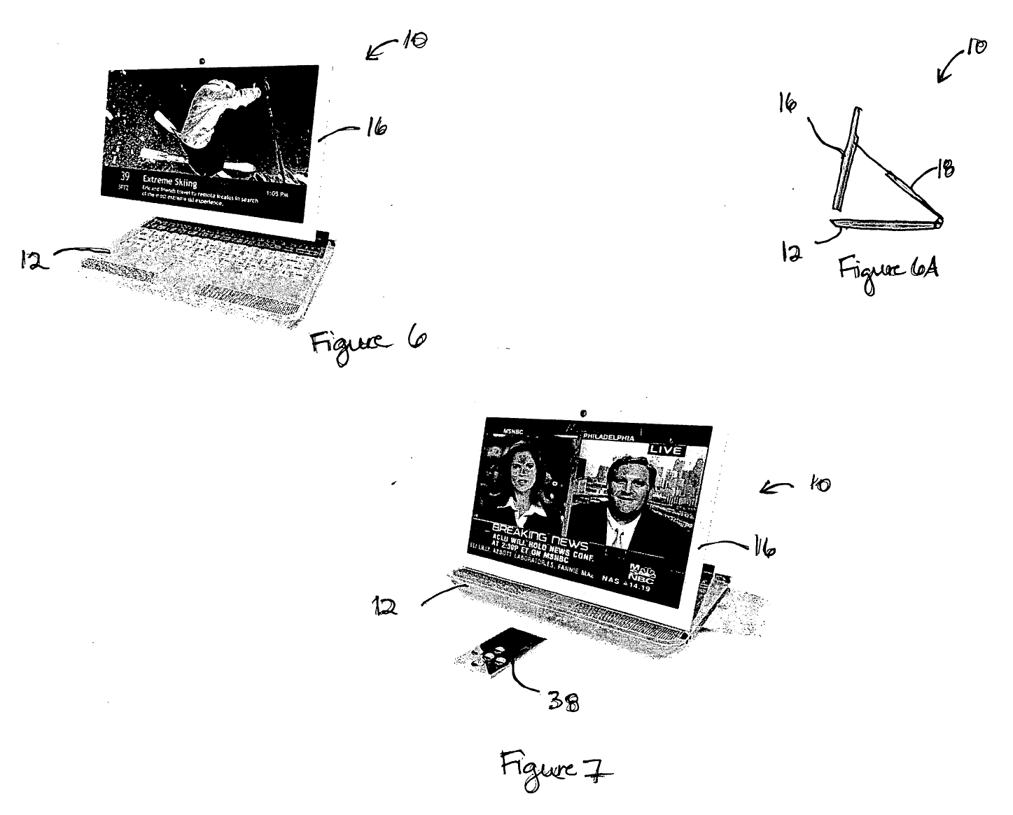

FIGS. 6 and 6A show the computer system 10 of FIG. 1 in a height-adjusted and pivoted open position. In the illustrated embodiment, the arm 18 has been extended, as in FIG. 5; however, the screen 16 has also been pivoted away from the arm 18.

The screen 16 may be pivoted by applying a force to the screen 16 to remove the arm 18 from the recess 34 and pivot the screen via the connection 32. The user can tilt the screen 16 to any angle desired. In one embodiment, the screen 16 may be able to flip around, as discussed above. Friction or other locking mechanisms may be used to secure the screen 16 at the desired angle.

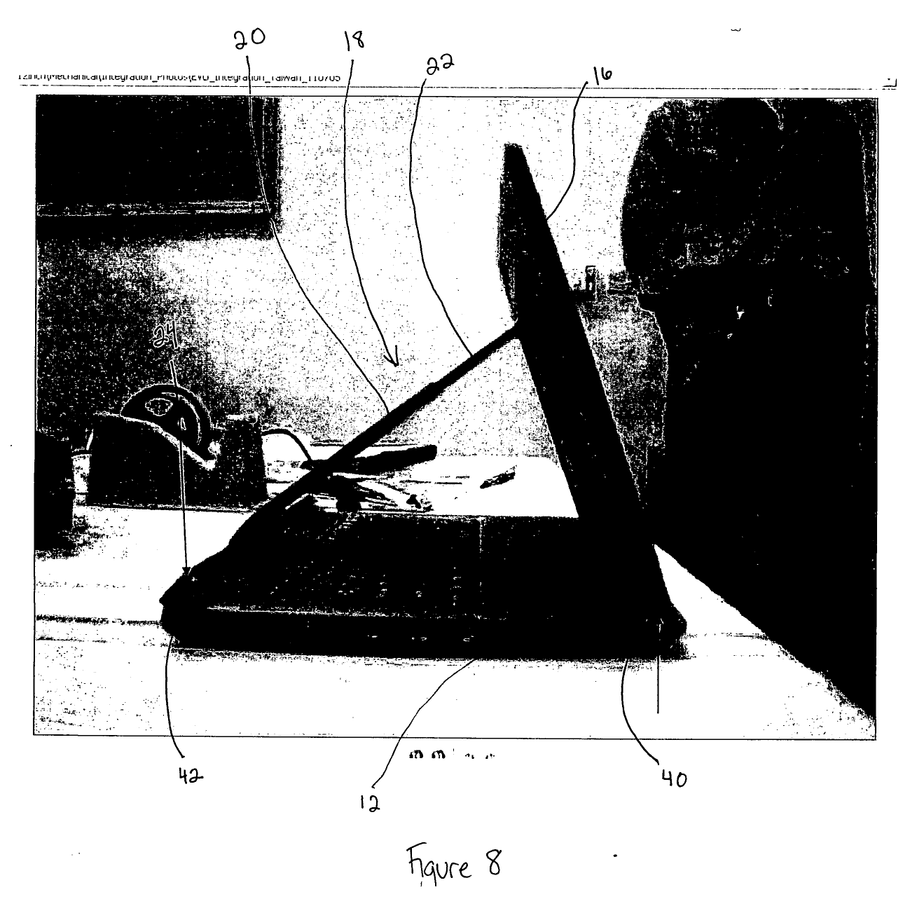

FIG. 7 shows the computer system 10 of FIG. 1 in a presentation position. In one embodiment, the bottom edge of the screen 16 rests on the base 12. Thus, there is no distance between the bottom of the screen 16 and the base 12. The screen 16 may be secured to the base 12.

To arrive at the presentation position, the height of the screen 16 may be adjusted. The arm 18 is also typically pivoted relative to the base 12. The screen 16 is also typically tilted relative to the arm 18. As described herein, the user typically applies a force, such as lifting and/or a rotation, to adjust the height and angle of the screen 16 and the angle of the arm 18.

A remote control 38 may be provided so that a user of the computer system 10 can control the computer system 10 without using the keys 14 on the base. Alternatively, the base 12 may be removed from the arm 18 and/or the keys 14 may be removed from the base 12. The screen 16 may also be a Liquid Crystal Display (LCD) screen that allows the user to control the computer system 10 via the screen 16.

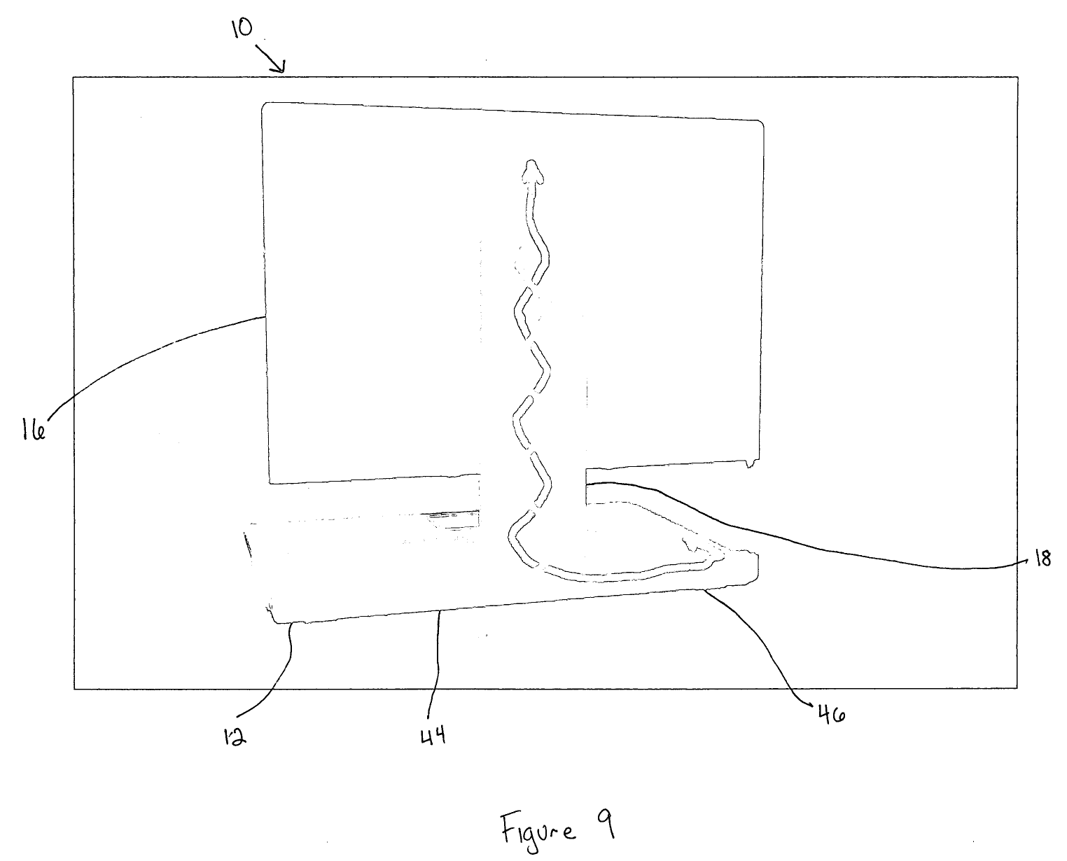

FIG. 8 is another view of the computer system 10 in the presentation mode. The base 12 may include a recess 40 for securing an end of the screen 16 in the presentation mode position. The third part 24 of the arm or the connection 30 of the base 12 may also include a recess 42 for receiving an end of the screen 16 in the open and/or closed positions shown in FIGS. 3 and 4. The screen 16 may include tabs (not shown) which removably securable in the recesses 40 and 42. Thus, using the tabs and recesses 40 and 42, the screen can be locked in position in the presentation mode, and/or the “conventional” closed and/or open positions. Other locking mechanisms may be provided to secure the screen 16 in any of these positions. In one embodiment, friction may be used to secure the screen 16 in a desired position.

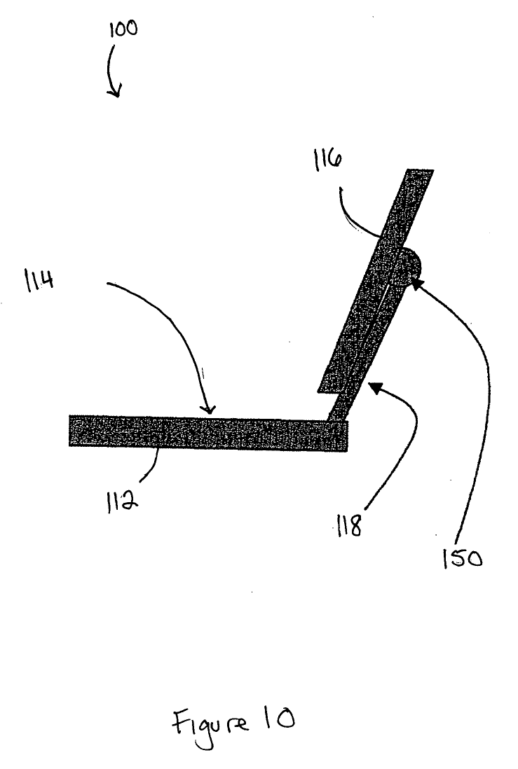

FIG. 9 shows a cross-sectional view of the arm 18. In one embodiment, the arm 18 includes first and second electrical connections 44 and 46, respectively. In one embodiment, the electrical connections 44 and 46 electrically connect the base 12 with the screen 16. The electrical connections 44 and 46 may include one or more wires.

The first and second electrical connections 44, 46 may pass from the base 12 and through the hinges 26 and 28, respectively, into the third part 24 of the arm 18. The electrical connections 44, 46 may continue through the third part 24 and within the first and second parts 20, 22 of the arm 18. The electrical connections 44, 46 may pass through the connection 32 to the screen 16.

The electrical connections 44, 46 are shown arranged in a “zigzag” pattern in the arm 18. That is, each of the electrical connections 44, 46 is arranged to have several bends when the arm 18 is in a non-extended position. The interior angle of each bend may be any angle or range of angles between about 0 and 180 degrees. In one embodiment, the interior angle of each bend is greater than 90 degrees to allow the electrical connections to extend when the extensible arm is extended. In one embodiment, the “zigzag” pattern provides flexibility to the electrical connections 44, 46, such that when the height of the screen 16 is adjusted relative to the base 12 (e.g., the arm 18 is extended), the electrical connections 44, 46 are not overly stressed. Thus, the electrical connections 44, 46 may still have a “zigzag” arrangement when the arm 18 is in an extended position, but the angle between the bends may be greater or the number of bends may be reduced, as compared to the non-extended position. The electrical connections 44, 46 may be arranged in a straight line when the arm 18 is fully extended. In one embodiment, the electrical connections 44, 46 desirably return to the “zigzag” arrangement when the arm 18 is returned to a non-extended position.

Although a “zigzag” pattern is shown, any arrangement of the electrical connections 44, 46 may be used which provides sufficient flexibility so that the height of the screen 16 can be adjusted without disconnecting the electrical connections 44 and 46 from the base 12 or screen 16.

As noted above, base 12 and screen 16 may be optically or wirelessly connected to one another. In such an embodiment, the electrical connections 44 and 46 may not be required.

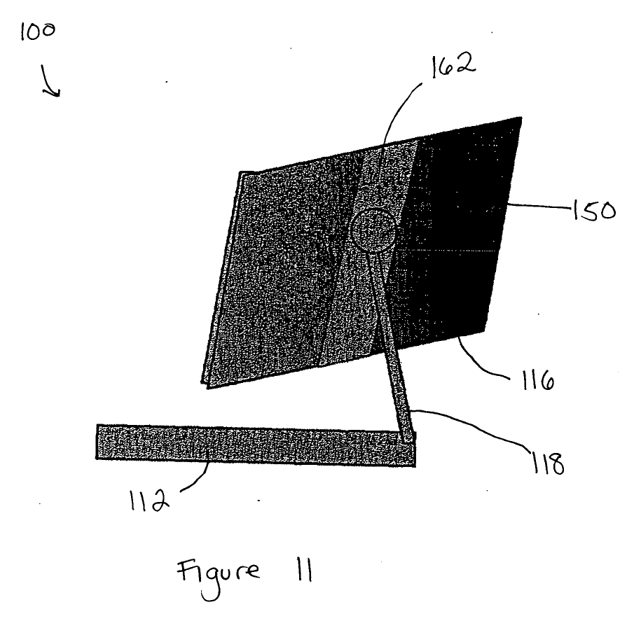

FIG. 10 shows a computer system 100. In one embodiment, the computer system 100 includes a base 112, a plurality of keys 114, a screen 116, an arm 118 and a ball joint 150. The arm 118 may be connectable with the ball joint 150. The ball joint 150 may also be connectable with the screen 116. Hinges (not shown) may connect the arm 118 to the base 112. The base 112 may support the plurality of keys 114.

In one embodiment, the ball joint 150 allows the screen 116 to be pivoted relative to the arm 118. The screen 116 may be tilted when a user applies a force, such as a rotation, such that the screen 116 rotates via the ball joint 150.

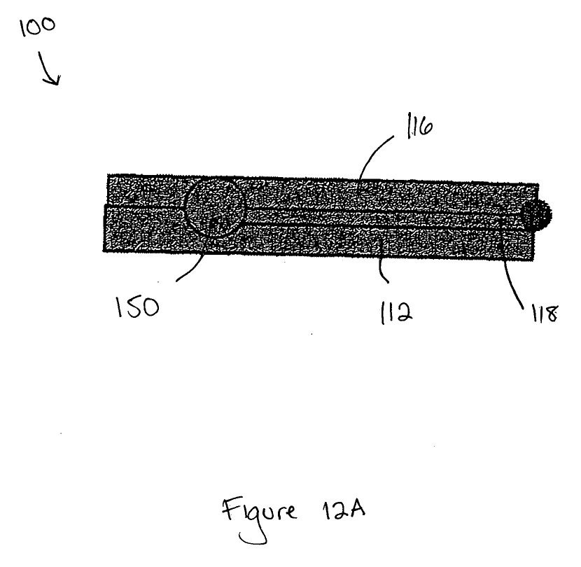

FIG. 11 shows the computer system 100 having a sliding mechanism 162 on a surface of the screen. In one embodiment, the sliding mechanism 162 allows the height of the screen 116 to be adjusted relative to the base 112.

The sliding mechanism 162 may include a recess or guide. The sliding mechanism 162 may be dimensioned to correspond to the ball joint 150. The ball joint 150 may be frictionally fit or otherwise secured within the sliding mechanism 162, such that the ball joint 150 can slide within the sliding mechanism 162, but can also be locked in any desired position. In one embodiment, the height of the screen 116 is adjustable even though the arm 118 may not be extensible.

In one embodiment, the user applies a force to the screen 116 such that the ball joint 150 slides within the sliding mechanism 162. The ball joint 150 can slide up or down within the sliding mechanism. Thus, the user may have to lift the screen 116 or push down on the screen 116.

It is envisioned that a ball joint, similar to the ball joint 150, may also be used with the extensible arm described above with reference to FIGS. 1-9.

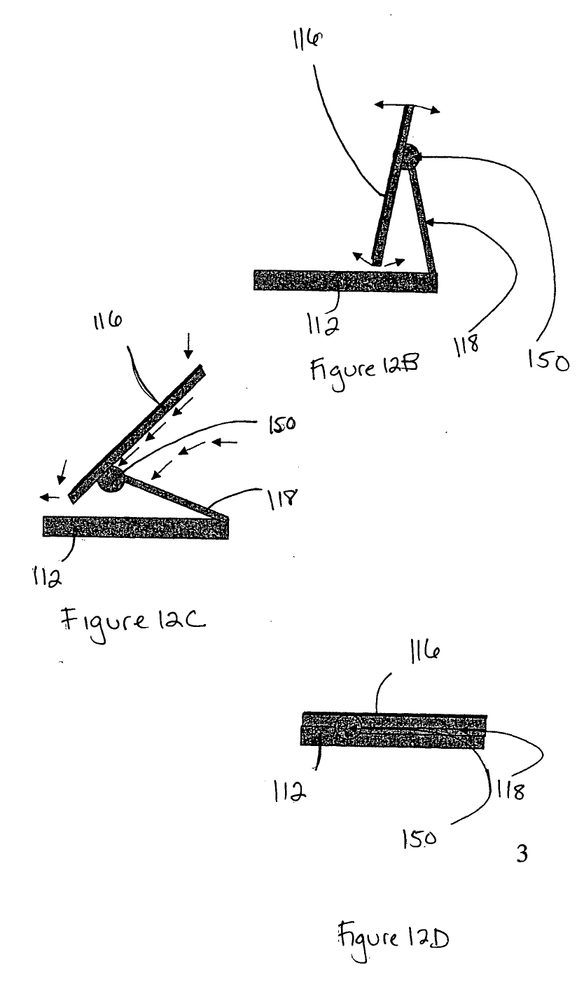

FIGS. 12A-12D show the range of motion for the computer system 100 of FIGS. 10 and 11. The computer system 100 is shown in a closed position in FIG. 12A. In FIG. 12B, the computer system 100 is shown in an open position, wherein the screen 116 is pivoted away from the arm 118. The computer system 100 is shown in a position in FIG. 12C in which the screen 116 is pivoted and the arm 118 is also pivoted at an angle. The ball joint 150 may slide in the sliding mechanism 162 to arrive at the illustrated position. The computer system is shown in FIG. 12D in a tablet position, wherein the display portion of the screen 116 is facing up. The ball joint 150 may also slide in the sliding mechanism 162 to arrive at the illustrated position.

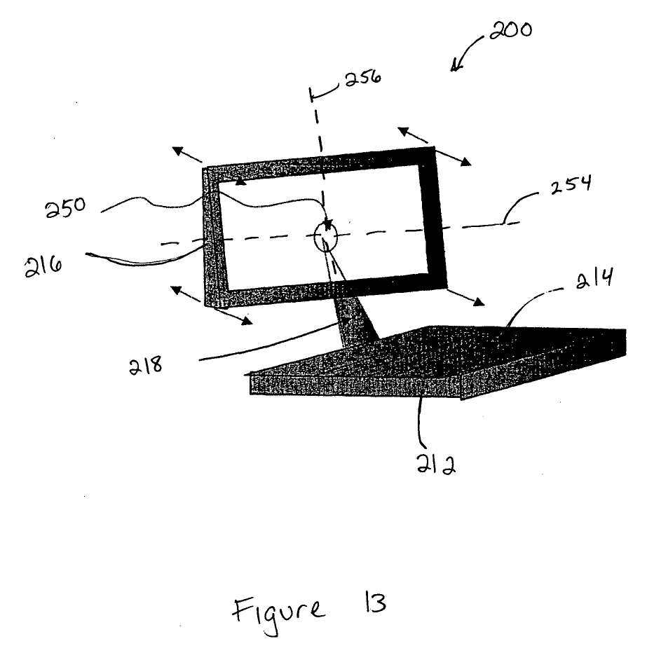

FIG. 13 shows a computer system 200. In one embodiment, the computer system 200 includes a base 212, a plurality of keys 214, a screen 216, an arm 218 and a ball joint 250. A first axis 254 is shown passing through the ball joint 250 and through the length of the screen 216. A second axis 256 is shown passing through the ball joint 250 and through the height of the screen 216.

The screen 216 may be pivotal about the first and second axes 254 and 256, respectively. The arm 216 may have a pointed end, or the arm 216 may have a connection (not shown) that allows the ball joint to have a full range of motion.

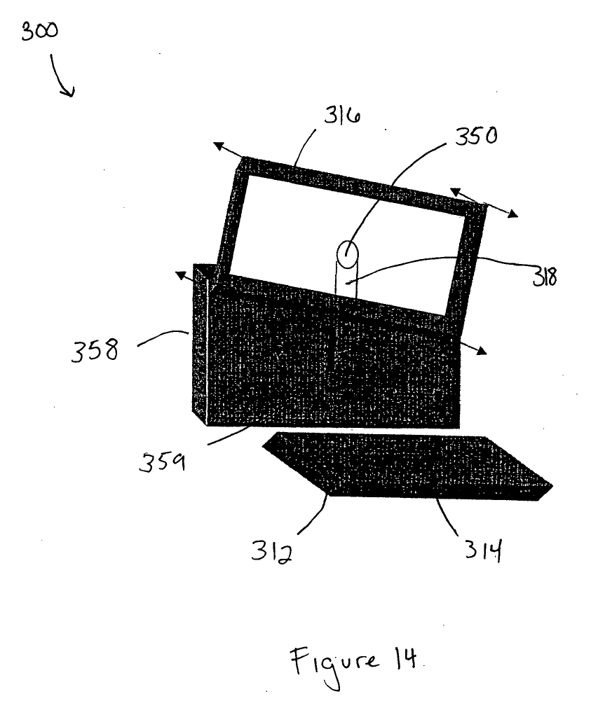

FIG. 14 shows a computer system 300. In one embodiment, the computer system 300 includes a base 312, a plurality of keys 314, a screen 316, an arm 318, a ball joint 350 and a support 358.

The support 358 and the screen 316 may be independent of the base 312. The support 358 is connectable with the screen 316. The screen 316 may be connected with the arm 318 and the ball joint 350. The base 312 may support the keys 314. The base 312 may be electrically connected to the screen 316. The screen 312 may also be wirelessly or optically connected to the screen 316.

The support 358 may include a recess 359 for slideably receiving the ball joint 350. The recess 359 may be similar to the sliding mechanism described above with reference to FIG. 11. Thus, the screen 316 may be height adjustable and may be pivoted via the ball joint 350, relative to the support, in a manner similar to that described above with reference to the computer system 100.

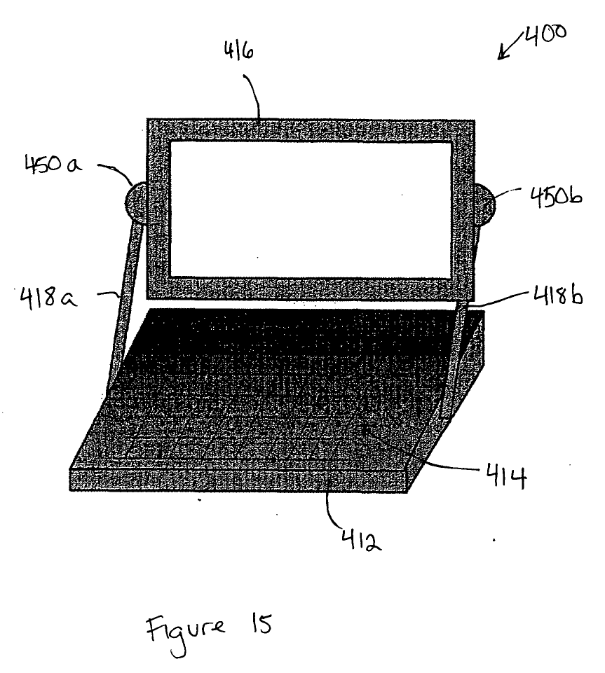

FIG. 15 shows a computer system 400. In one embodiment, the computer system 400 includes a base 412, a plurality of keys 414, a screen 416, first and second arms 418a and 418b, respectively, and first and second ball joints 450a and 450b, respectively. The base 412 may support the keys 414. The base 412 may be electrically connected to the screen 416.

The first and second arms 418a and 418b are shown connected with the base 412 and the screen 416 at opposing ends of the base 412 and screen 416. In one embodiment, each of the first and second arms 418a and 418b, respectively, are connectable with the first and second ball joints 450a and 450b, respectively.

The ball joints 450a and 450b may be slideable, such that the height of the screen 416 is adjustable relative to the base 412. The angle of the screen 416 may also be adjustable via first and second ball joints 450a and 450b, respectively.

Although the arms 418a and 418b are shown connected with ball joints, it is envisioned that arms 418a and 418b may be used with the computer system 10 described above with reference to FIGS. 1-9 (i.e., without the ball joints 450a and 450, and/or arms 418a and 418b may be extensible).

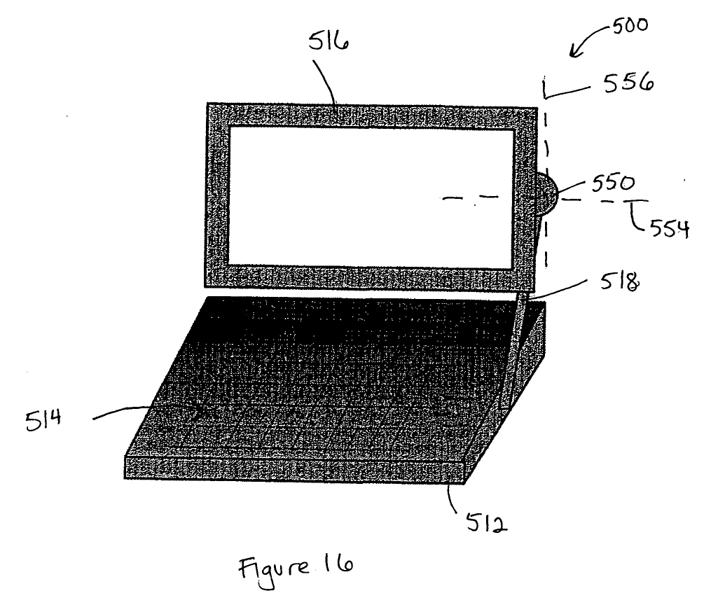

FIG. 16 shows a computer system 500. In one embodiment, the computer system 500 includes a base 512, a plurality of keys 514, a screen 516, an arm 518 and a ball joint 550. The base 512 may support the keys 514. The base 512 may be electrically connected to the screen 516.

In one embodiment, the arm 518 is connectable with the base 512 and the screen 516 at one of its sides. The screen 516 may be swivelable about both axes 554 and 556. In one embodiment, the computer system 500 also includes a sliding mechanism (not shown) on the side of the screen, which is connectable with the ball joint 550.

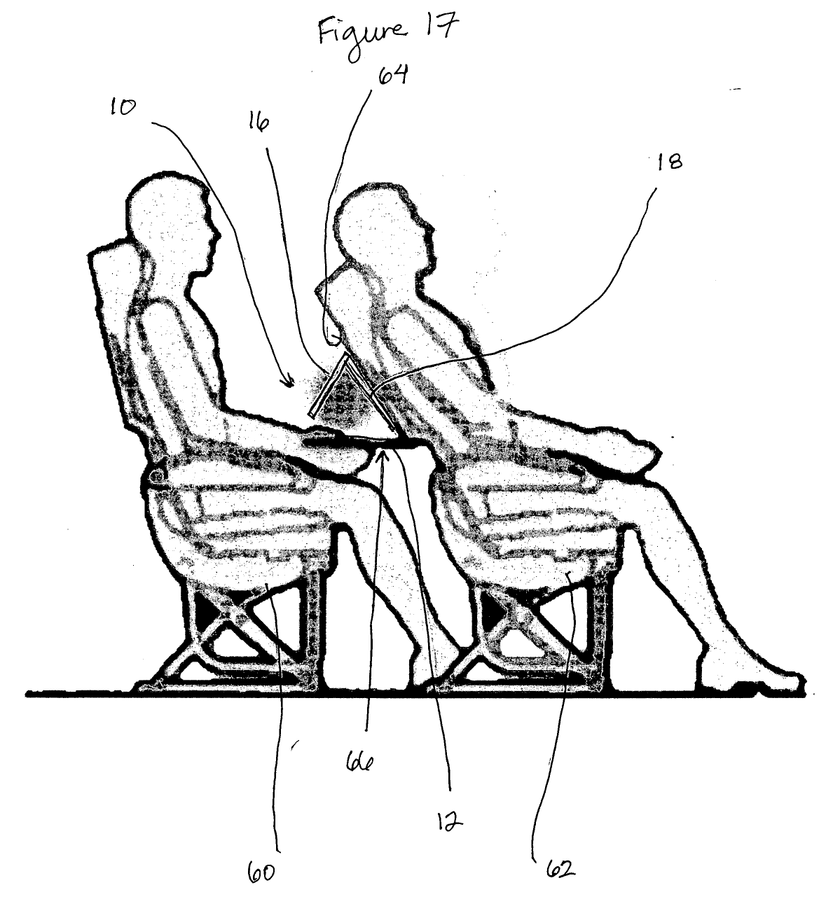

FIG. 17 shows the computer system 10 of FIG. 1 in use in accordance with one embodiment of the invention. Although computer system 10 is shown in FIG. 17, it is envisioned that the other computer systems described herein may also be used.

A first passenger 60 is shown in a plane, seated behind a second passenger 62. The second passenger 62 is seated in a seat having a seat back 64. A tray 66 is connected to the seat back 64.

The computer system 10 of the first passenger 60 is shown positioned on the tray 66. In one embodiment, when the second passenger 62 adjusts the seat back 64 into a reclined position (shown in FIG. 17), the first passenger 60 can pivot the arm 18 and/or the screen 16, and/or adjust the height of the screen. Thus, the user can view the screen 16 and still access the keys 14 on the base 12 of the computer system 10 when the second passenger 62 reclines their seat back 64.

The computer systems described herein may be adjustable to several positions. At least one or more of the following modes may be available to a user: a traditional laptop mode, an ergonomic mode, a compressed workspace mode, a presentation mode, and a tablet mode.

In the traditional laptop mode, the computer system may open and close similar to conventional clamshell-type laptop computers as described hereinabove. In the ergonomic mode, a user can adjust the height of the screen relative to the base, such that the computer is more ergonomic than conventional laptop computers. In the compressed workspace mode, the screen may be pivotal. The height of the screen can also be adjusted to allow the users hands to fit under the screen for us of the keyboard and/or allow for a better ergonomic viewing position. In the presentation mode, the screen can extend toward the front of the base and cover the keys. The keyboard can also be removed. The computer can be remotely controlled or can be used with a touch screen to allow use without a keyboard. In the tablet mode, the screen may be facing upward and is operated similar to the presentation mode.

The pivotal range of motion for the screen with respect to the base may be up to about 180 degrees. The pivotal range of motion for the screen with respect to the extensible arm may also e up to about 180 degrees.

In some embodiments, the computer systems described herein may have the above positions pre-set. That is, the positions for one or more of the above modes may be predetermined.

The computer system may be programmed to automatically adjust the brightness of the image displayed on the screen according to the position of the screen in any mode. For example, if the screen is tilted forward, the image displayed on the screen may be dimmed.

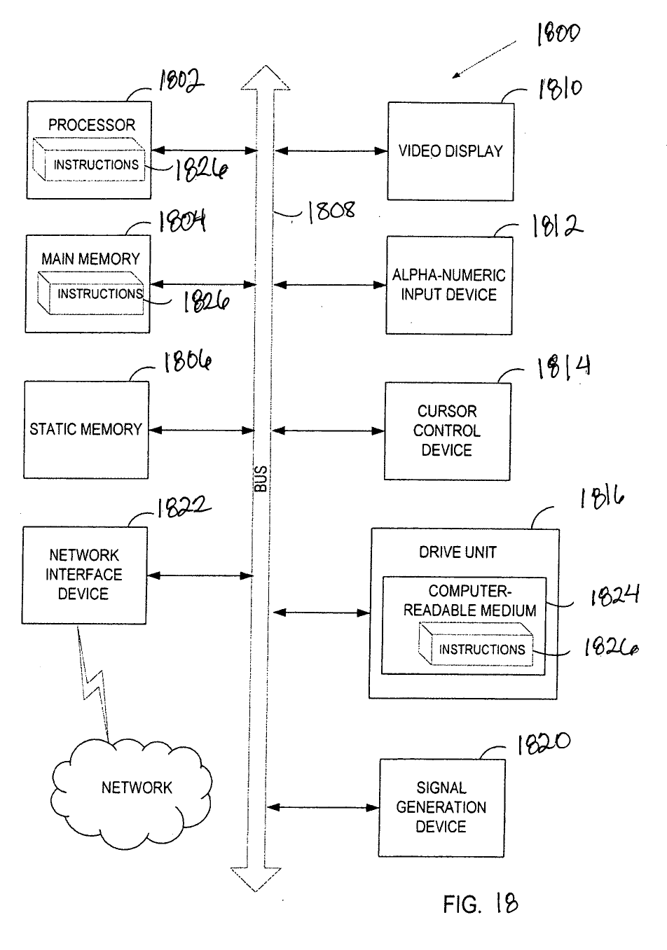

FIG. 18 shows a diagrammatic representation of machine in the exemplary form of a computer system 1800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1800 includes a processor 1802 (e.g., a central processing unit (CPU), a graphics processing unit (GPU) or both), a main memory 1804 (e.g., read only memory (ROM), flash memory, dynamic random access memory (DRAM) such as synchronous DRAM (SDRAM) or Rambus DRAM (RDRAM), etc.) and a static memory 1806 (e.g., flash memory, static random access memory (SRAM), etc.), which communicate with each other via a bus 1808.

The computer system 1800 may further include a video display unit 1810 (e.g., a liquid crystal display (LCD) or a cathode ray tube (CRT)). The computer system 1800 also includes an alphanumeric input device 1812 (e.g., a keyboard), a cursor control device 1814 (e.g., a mouse), a disk drive unit 1816, a signal generation device 1820 (e.g., a speaker) and a network interface device 1822.

The disk drive unit 1816 includes a machine-readable medium 1824 on which is stored one or more sets of instructions (e.g., software 1826) embodying any one or more of the methodologies or functions described herein. The software 1826 may also reside, completely or at least partially, within the main memory 1804 and/or within the processor 1802 during execution thereof by the computer system 1800, the main memory 1804 and the processor 1802 also constituting machine-readable media.

The software 1826 may further be transmitted or received over a network 1828 via the network interface device 1822.

While the machine-readable medium 1824 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The computer system 1800 may include optical or wireless connections.

The foregoing description with attached drawings is only illustrative of possible embodiments of the described method and should only be construed as such. Other persons of ordinary skill in the art will realize that many other specific embodiments are possible that fall within the scope and spirit of the present idea. The scope of the invention is indicated by the following claims rather than by the foregoing description. Any and all modifications which come within the meaning and range of equivalency of the following claims are to be considered within their scope.

1. A computer system comprising:
a base module;
a plurality of keys supported by the base module;
at least one extensible arm having first and second ends, the first end being pivotally secured to the base module; and
a display module secured to the second end of the extensible arm.

2. The computer system of claim 1, wherein the extensible arm comprises a first part and a second moveable part, the second movable part telescopically moveable with respect to the first part.

3. The computer system of claim 1, wherein the display module is pivotally secured to the second end of the extensible arm.

4. The computer system of claim 1, wherein the extensible arm is removably secured to the base module.

5. The computer system of claim 1, wherein the extensible arm comprises at least one electrical connection to electrically connect the base module with the display module.

6. The computer system of claim 5, wherein the electrical connection is arranged within the arm in a series of bends, where each bend has an interior angle of greater than 90 degrees to allow the electrical connections to extend when the extensible arm is extended.

7. The computer system of claim 1, wherein the at least one extensible arm comprises a first extensible arm and a second extensible arm.

8. The computer system of claim 1, wherein the at least one extensible arm is connectable with a ball joint at the second end, the ball joint connectable with the display module.

9. The computer system of claim 1, wherein the display module is swivelable relative to the extensible arm.

10. The computer system of claim 3, wherein the extensible arm is extensible to a distance that allows the plurality of keys to be seen by a user when the arm is fully extended and pivoted toward the user.

11. The computer system of claim 1, wherein the extensible arm comprises a first fixed part and a second moveable part, the second movable part telescopically moveable with respect to the first fixed part and wherein the display module is pivotally secured to the second end of the extensible arm.

12. The computer system of claim 11, wherein the extensible arm to extend upward and at an angle toward the user when the arm is extended

13. The computer system of claim 12, wherein the display module is pivotal in a range of motion of up to 180 degrees with respect to the base.

14. The computer system of claim 11, wherein the display module is pivotal in a range of motion up to 180 degrees with respect to the extensible arm.

15. The computer system of claim 13, wherein the display module the display module includes a recess to receive at least a portion of the extensible arm when the display module is not pivoted.

16. A computer system comprising:
a base module having a plurality of keys;
a display module;
a hinge connectable with the base and connectable with the display module, a distance between the display module and the base module adjustable independent of an angle between the display module and the base module.

17. The computer system of claim 16, wherein the angle of the display module is adjustable with respect to the base module.

18. The computer system of claim 17, wherein the angle of the display module is adjustable about an axis passing through the display module where the hinge is connectable with the display module.

19. A computer system comprising:
a base module;
a plurality of keys supported by the base;
at least one arm having first and second ends, the first end being pivotally secured to the base module; and
a display module secured to the second end of the arm, the display module being pivotal relative to the arm.

20. The computer system of claim 19, wherein the at least one arm comprises first and second arms, the display module being pivotal relative to the first and second arms.

21. The computer system of claim 19, wherein the second end of the arm is connectable with a ball joint, the ball joint connectable with the display module.

22. The computer system of claim 19, wherein the display module is swivelable relative to the arm.

23. A method comprising:
fabricating a computer system having a base module, at least one extensible arm having first and second ends, the first end being pivotally secured to the base module, and a display module secured to the second end of the extensible arm.

24. The method of claim 23, wherein the at least one extensible arm is removably secured to the base module.

25. The method of claim 23, wherein the at least one extensible arm is pivotally secured to the display module.

26. A computer system comprising:
a base module;
a plurality of keys supported by the base module;
at least one extensible arm having first and second ends, the first end being pivotally secured to the base module; and
a display module pivotally attached to the second end of the extensible arm, wherein the display module is pivotal in a range of motion of up to 180 degrees with respect to the base and the extensible arm to extend upward and at an angle toward the user when the arm is extended.
